(19) United States
(12) Patent Application Publication
(10) Pub. No.: US 2010/0146733 A1
(43) Pub. Date: Jun. 17, 2010

(54) HINGE AND COLLAPSIBLE DEVICE UTILIZING THE SAME

(75) Inventor: WEN-BIN SHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/477,869

(22) Filed: Jun. 3, 2009

(30) Foreign Application Priority Data
Dec. 12, 2008 (CN) 200810306207.6

(51) Int. Cl. E05F 1/08

(52) U.S. Cl. 16/297

(57) ABSTRACT

A hinge includes a first connecting member, a shaft fixed to the first connecting member, a second connecting member rotatably mounted to the shaft, a positioning member, an elastic ring, and a fastener. The shaft includes a fixing end. The second connecting member includes a positioning post having a slant resisting surface. The positioning member is unrotatably mounted to the fixing end, and includes a positioning protrusion resisting against the positioning post. The positioning protrusion includes a withstanding surface corresponding to the resisting surface. The elastic ring is rotatably mounted to the shaft and abutted against the positioning member. The fastener is adjustably fixed to a distal end of the fixing end. During rotation of the second connecting member relative to the first connecting member to a predetermined degree, the resisting surface resists against the corresponding withstanding surface for driving the positioning member to deform the at elastic ring.

### BACKGROUND

1. Technical Field

The disclosure relates to a hinge, and a collapsible device utilizing the hinge.

2. Description of Related Art

A collapsible device, such as a notebook computer, or a clamshell mobile phone, generally including a base and a cover often uses a hinge to interconnect the base and the cover. The hinge allows the cover to be rotatable with respect to the base, and to be folded with the base for saving space.

A hinge normally includes a first element and a second element fixed to the base and the cover of the collapsible device, respectively. The first and second elements are rotatable relative to and in friction engagement with each other for maintaining the cover at a determined angle with respect to the base. However, the first and second elements are not durable after frequent usage and due to wear and tear, as a result, the cover cannot maintain stability at the determined angle with respect to the base, which is quite inconvenient for users. Moreover, when the cover is rotated by excessive force, the cover may be rotated over the determined angle resulting in damaging the hinge.

### BRIEF DESCRIPTION OF THE DRAWINGS

FIG. 1 is an exploded, isometric view of an exemplary embodiment of a hinge, the hinge including a first connecting member and a second connecting member.

FIG. 2 is an inverted view of the hinge of FIG. 1.

FIG. 3 is an assembled, isometric view of the hinge of FIG. 2.

FIG. 4 is similar to FIG. 3, but showing the second connecting member being rotated an angle relative to the first connecting member.

FIG. 5 is an isometric view of an exemplary embodiment of a collapsible device utilizing the hinge of FIG. 1.

### DETAILED DESCRIPTION

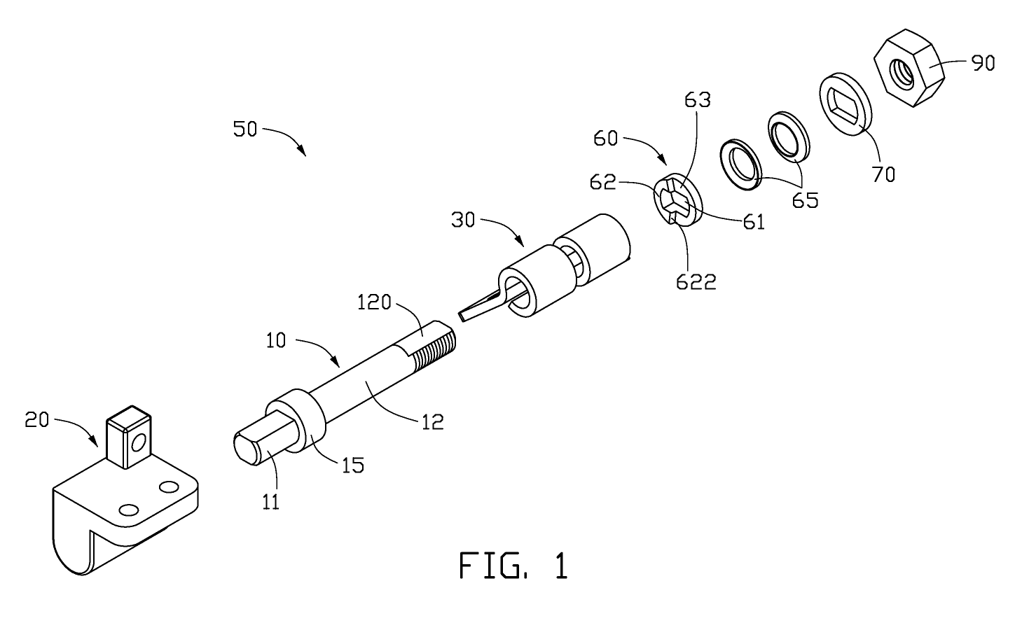

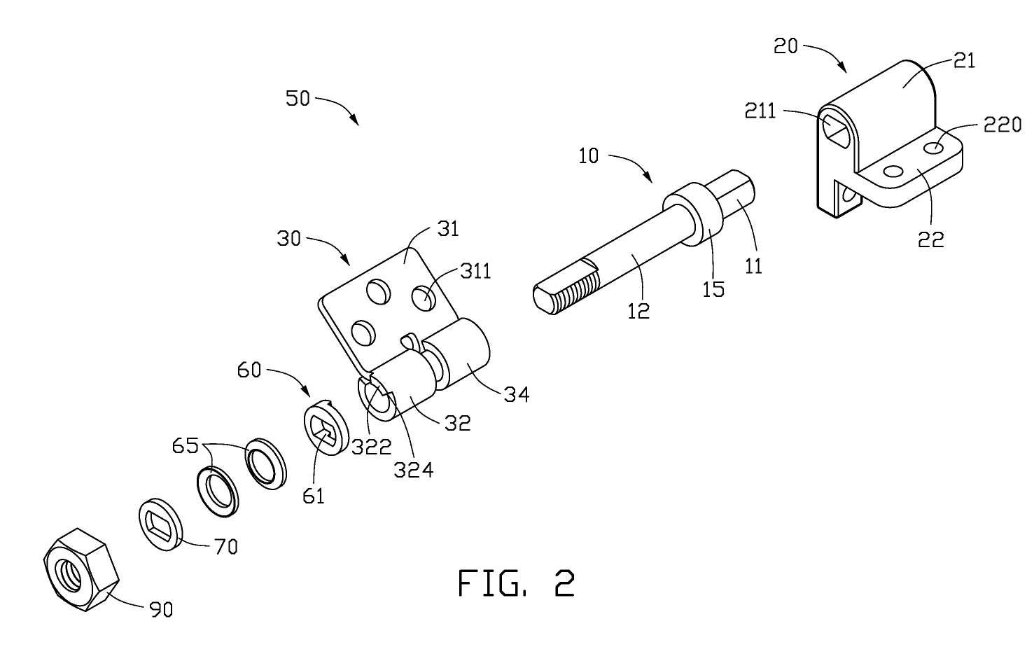

Referring to FIGS. 1 and 2, an exemplary embodiment of a hinge 50 includes a shaft 10, a first connecting member 20, a second connecting member 30, a positioning member 60, a plurality of elastic rings 65, a washer 70, and a fastener 90. In the embodiment, the fastener 90 is a nut.

The shaft 10 includes a fixing portion 11, a shaft body 12, and a resisting portion 15 between the fixing portion 11 and the shaft body 12. The fixing portion 11 has a double-D shaped cross-section for fixing the first connecting member 20. The shaft body 12 includes a fixing end 120 away from the resisting portion 15, and the fixing end 120 has a double-D shaped cross-section, and forms a threaded portion (not labeled) on a circumference of the fixing end 120.

The first connecting member 20 includes a connecting portion 22 defining a plurality of fixing holes 220, and a cylinder-shaped fixing portion 21 located on a side of the connecting portion 22. The fixing portion 21 axially defines a fixing hole 211 having a double-D shape, corresponding to the fixing portion 11 of the shaft 10, for fixing the fixing portion 11 with the shaft 10.

The second connecting member 30 includes a connecting body 31 defining a plurality of fixing holes 311. Two separate portions respectively bend from a side of the connecting body 31, along two opposite directions to form a first curly sleeve 34 and a second curly sleeve 32. The first and second sleeves 34 and 32 are coaxial, and allow the shaft body 12 to pass therethrough in that turn. A positioning post 322 axially extends from an end surface of the second sleeve 32, opposite to the first sleeve 34. The positioning post 322 includes two resisting surfaces 324 slantingly extending from opposite sides of the positioning post 322, and connecting with the end surface of the second sleeve 32.

The positioning member 60 defines a through hole 61 having a double-D shaped cross-section, corresponding to the fixing end 120 of the shaft 10, therefore, the positioning member 60 is unrotatably mounted to the fixing end 120. The positioning member 60 includes a matching side surface 63, and a C-shaped positioning protrusion 62 extends from the matching side surface 63 and around the through hole 61. Two opposite ends of the positioning protrusion 62 each forms a withstanding surface 622 slantingly extending to connect with the side surface 63 of the positioning member 60.

Each elastic ring 65 provides elasticity along an axial direction of the shaft 10, to tighten the positioning member 60, the first connecting member 20, and the second connecting member 30. Each elastic ring 65 defines a round through hole (not labeled), allowing the shaft body 12 of the shaft 10 to rotatably pass therethrough.

The washer 70 defines a double-D shaped through hole (not labeled) in a center of the washer 70, for unrotatably fitting about the shaft body 12 of the shaft 10.

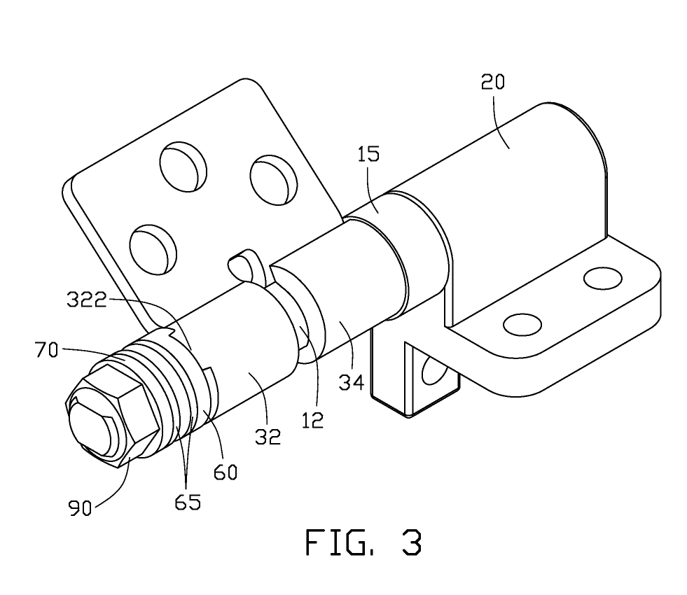

Referring to FIG. 3, in assembly, the fixing portion 11 of the shaft 10 is fixedly received in the fixing hole 211 of the first connecting member 20, therefore, the shaft 10 is fixed to the first connecting member 20. The shaft body 12 of the shaft 10 is rotatably passed through the first sleeve 34, the second sleeve 32, the positioning member 60, the plurality of elastic rings 65, and the washer 70 one by one in that order, with the fixing end 120 of the shaft body 12 engaging in the fastener 90 for preventing the second connecting member 30, the positioning member 60, the plurality of elastic rings 65, and the washer 70 from disengaging from the shaft 10. In the aforementioned assembly, the first sleeve 34 resists against the resisting portion 15 of the shaft 10, and the matching side surface 63 of the positioning member 60 faces the positioning post 322 of the second sleeve 32, with the positioning protrusion 62 frictionally resisting against the end surface of the second sleeve 34.

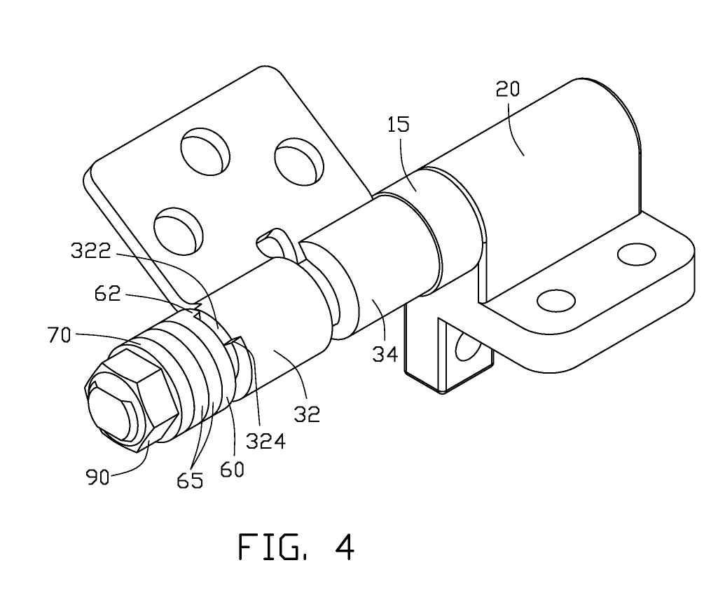

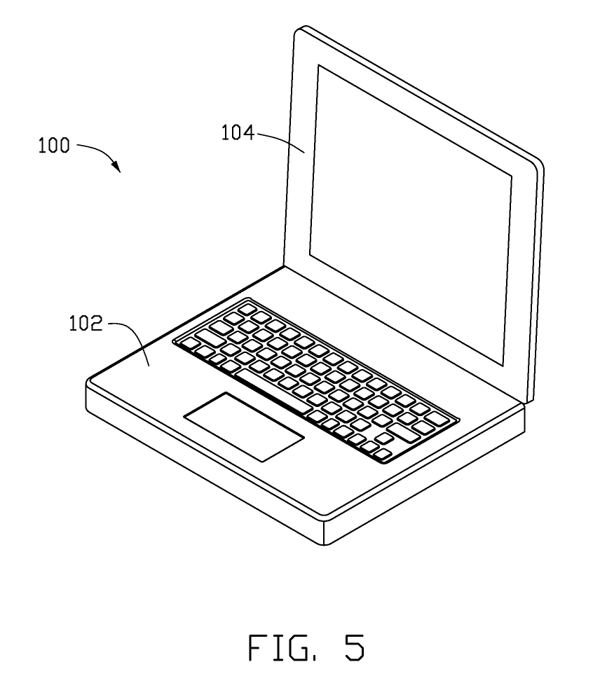

Referring to FIGS. 4 and 5, in use, the above-mentioned hinge 50 is utilized in a collapsible device 100, here for instance, in a notebook computer that includes a base 102 and a cover 104. The first connecting member 20 is fixed to one of the cover 104 and the base 102 via the plurality of fixing holes 220, and the second connecting member 30 is fixed to the other one of the cover 104 and the base 102 via the plurality of fixing holes 311. Therefore, during rotation of the cover 104 relative to the base 102, the second connecting member 30 rotates relative to the first connecting member 20, with the shaft 10 freely rotating in the first and second sleeves 34, 32. When one of the resisting surfaces 324 of the second connecting member 30 resists against a corresponding withstanding surface 622 of the positioning member 60, the cover 104 is stably maintained at a determined angle with respect to the base 102. Consequently, the second connecting member 30 cannot be rotated further, as a result, the cover 104 cannot be over-rotated.

Moreover, when the cover 104 is over-rotated by excessive force, the resisting surface 324 of the connecting member 30 drives the corresponding withstanding surface 622 to move along the axial direction of the shaft 10 away from the second sleeve 32 of the second connecting member 30, to deform the plurality of elastic rings 65. As a result, the resisting surface 324 is disengaged from the corresponding withstanding surface 622, for avoiding damaging the hinge 50.

In addition, the fastener 90 can be rotated along the fixing end 120 of the shaft 10 to tighten or loosen the positioning member 60 and the second connecting member 30, resulting in increasing or reducing friction between the positioning member 60 and the second connecting member 30.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1 A hinge comprising,
a first connecting member;
a shaft unrotatably fixed to the first connecting member, and comprising a fixing end opposite to the first connecting member;
a second connecting member rotatably mounted to the shaft, and comprising a positioning post, wherein the positioning post comprises a slant resisting surface;
a positioning member unrotatably mounted to the fixing end of the shaft, and comprising a positioning protrusion to resist against the positioning post, the positioning protrusion comprising a withstanding surface corresponding to the resisting surface of the positioning post;
at least one elastic ring rotatably mounted to the shaft and abutting against the positioning member, opposite to the second connecting member; and
a fastener adjustably fixed to the fixing end of the shaft, to prevent the second connecting member, the positioning member, and the at least one elastic ring from disengaging from the shaft;
wherein during rotation of second connecting member relative to the first connecting member to a predetermined degree, the resisting surface resists against the corresponding withstanding surface for driving the positioning member to move away from the second connecting member to deform the at least one elastic ring.

2. The hinge of claim 1, wherein the shaft further comprises a resisting portion and a shaft body extending from the resisting portion, wherein the fixing end is located at a distal end of the shaft body away from the resisting portion, the second connecting member is rotatably mounted to the shaft body and resists against the resisting portion.

3. The hinge of claim 1, wherein the second connecting member comprises a connecting body and a first curly sleeve bent from a side of the connecting body, the positioning post axially extends from one end surface of the first sleeve.

4. The hinge of claim 3, wherein the second connecting member further comprises a second curly sleeve coaxial with the first sleeve, opposite to the positioning post, the shaft is passed through the second and first sleeves in that order.

5. The hinge of claim 1, wherein the positioning member defines a through hole for allowing the shaft to pass therethrough.

6. The hinge of claim 5, wherein the positioning member comprises a matching side surface facing the positioning post, the positioning protrusion is C-shaped and protrudes out from the matching side surface and around the through hole of the positioning member.

7. A collapsible device comprising:
a base;
a hinge comprising:
a first connecting member;
a shaft unrotatably fixed to the first connecting member, and comprising a fixing end opposite to the first connecting member;
a second connecting member rotatably mounted to the shaft, and comprising a positioning post, opposite sides of the positioning post each comprising a slant resisting surface;
a positioning member unrotatably mounted to the fixing end of the shaft, and comprising a positioning protrusion resisting against the positioning post, each opposite end of the positioning protrusion each forming a withstanding surface corresponding to the resisting surface;
at least one elastic ring rotatably mounted to the shaft and abutting against the positioning member; and
a fastener adjustably fixed to a distal end of the fixing end of the shaft to prevent the second connecting member, the positioning member, and the at least one elastic ring from disengaging from the shaft; and
a cover pivotally mounted to the base via the hinge;
wherein the first connecting member is fixed to one of the base and the cover, and the second connecting member is fixed to the other one of the base and the cover; during rotation of the cover relative to the base to a predetermined degree, one of the resisting surfaces resists against the corresponding withstanding surface for driving the positioning member to move away from the second connecting member to deform the at least one elastic ring.

8. The collapsible device of claim 7, wherein the shaft further comprises a resisting portion and a shaft body extending from the resisting portion, wherein the fixing end is located at the shaft body away from the resisting portion, the second connecting member is rotatably mounted to the shaft body and resists against the resisting portion.

9. The collapsible device of claim 7, wherein the second connecting member comprises a connecting body and a first curly sleeve bent from a side of the connecting body, the positioning post axially extends from one end surface of the first sleeve.

10. The collapsible device of claim 9, wherein the second connecting member further comprises a second curly sleeve coaxial with the first sleeve, opposite to the positioning post, the shaft is passed through the second and first sleeves in that order.

11. The collapsible device of claim 9, wherein the connecting body defines a plurality of fixing holes for fixing the second connecting member to one of the cove and the main body.

12. The collapsible device of claim 7, wherein the positioning member defines a through hole for allowing the shaft to pass therethrough.

13. The collapsible device of claim 12, wherein the positioning member comprises a matching side surface facing the positioning post, the positioning protrusion is C-shaped and protrudes out from the matching side surface and around the through hole of the positioning member.

14. The collapsible device of claim 7, wherein the first connecting member comprises a connecting portion defining a plurality of fixing holes, for fixing the first connecting member to one of the cove and the main body.
